(19) United States
(12) Patent Application Publication
(10) Pub. No.: US 2015/0068459 A1
(43) Pub. Date: Mar. 12, 2015

(54) PET BED

(71) Applicant: Simone Leffler, West Bradenton, FL (US)

(72) Inventor: Simone Leffler, West Bradenton, FL (US)

(21) Appl. No.: 14/022,473

(22) Filed: Sep. 10, 2013

(51) Int. Cl. A01K 1/035

(52) U.S. Cl. CPC A01K 1/0353
USPC 119/28.5

(57) ABSTRACT

A pet bed that includes a bed surface surrounded by panels where the entire bed surface and panels are made of memory foam. In one particular embodiment, the pet bed is rectangular in shape with side, front and rear panels surrounding the bed surface. Another particular embodiment relates to a circular or round bed surface surrounded by a rear panel where the bed may be shallow or deep in depth.

### BACKGROUND OF THE INVENTION

1. Field of Invention The present invention relates to pet bed made of memory foam to provide a resilient bed for a pet.

2. Description of Related Art

Many pet owners need various pet accessories for their pet's comfort and well being. One particular accessory that many pet owners have is a bed or some sort of a basket arrangement for the pet to sleep or lounge at their leisure. Many times these pet beds become worn over a period of time. The pet bedding available normally loses its form after excessive use and various machine washing and drying that may be associated with the bed area material. Consequently it would be advantageous to have a more durable material for a pet bed.

### SUMMARY OF THE INVENTION

The present invention relates to a pet bed that includes a bed surface surrounded by panels where the entire bed surface and panels are made of memory foam. In one particular embodiment, the pet bed is rectangular in shape with side, front and rear panels surrounding the bed surface. Another particular embodiment relates to a circular or round bed surface surrounded by a rear panel where the bed may be shallow or deep in depth.

### BRIEF DESCRIPTION OF DRAWINGS

FIG. 1 depicts a first embodiment of the pet bed in accordance with the present invention.

FIG. 2 depicts a second embodiment of the pet bed in accordance with the present invention.

FIG. 3 depicts a third embodiment of the pet bed in accordance with the present invention.

### DETAILED DESCRIPTION

The present invention relates to a pet bed that's manufactured of a memory foam material. The memory foam material provides a stable and resilient foam material that ensures the longevity or useful life of a pet bed. The pet bed in accordance with the present invention may include a removable water resistant cover and the top cover may be decorated with various seasonal features. Further the present invention may come in various shapes and sizes in order to accommodate the user's needs.

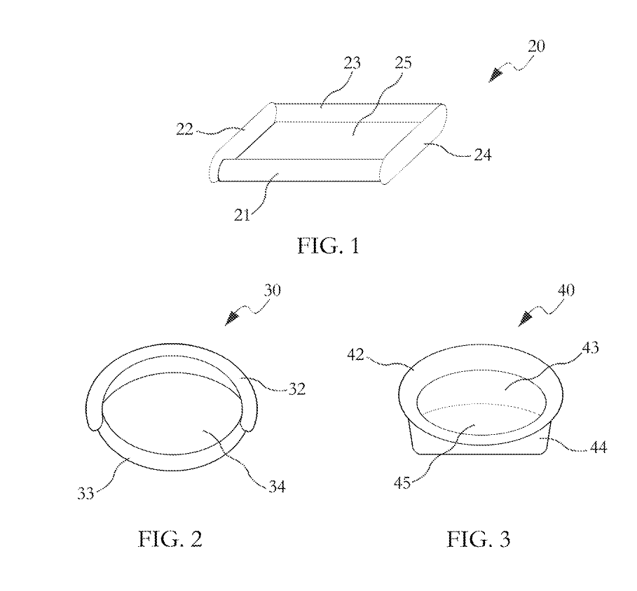

In reference to FIG. 1, a rectangular pet bed 20 is depicted. The rectangular pet bed 20 includes a bed surface 25 surrounded by side panels 22, 24, front panel 21 and rear panel 23. The rectangular shaped bed may be used as desired and includes a resilient memory foam material throughout the components of the bed. An alternative embodiment is shown in FIG. 2, a second pet bed 30 is depicted. The pet bed 30 includes a round circular bed surface 34 with a front lip 33. A raised panel around a rear portion of the bed surface 34. This particular embodiment provides an alternative shape for the pet bed in accordance with the present invention. Similar to the first embodiment all components are made of memory foam and may include a water resistant cover to cover the foam material.

A third alternative is depicted in FIG. 3 of a pet bed 40. The pet bed 40 includes a circular bed surface 45 however a deeper opening is provided for the bed. A rear wall 43 is shown that is raised above the bed surface 45 and this rear wall includes a lip 42 that surrounds the entire wall 43. A front wall 44 is provided with lower height as compared to the rear wall 43 to provide an entranceway for the pet. The present invention helps to provide a stable and durable pet bed that retains its shape over the course of time. The pet bed or lounge area may come in various sizes and as shown different shapes may be provided for the pet bed.

What is claimed:

1. A pet bed comprising:
a flat rectangular bed surface;
a first side panel, on a first side of the rectangular bed surface;
a second side panel on a second side of the rectangular bed surface;
a front panel extending across the rectangular bed surface; and
a rear panel extending across the rear surface of the rear portion of the bed surface, wherein each component of the pet bed is manufactured of memory foam materials.

2. A pet bed comprising:
a circular bed surface;
a front lip around a portion of a front circumference of the circular bed surface; and
a rear lip around a portion of the circumference of the circular bed surface, wherein the bed surface and components were made of memory foam material.

3. The pet bed according to claim 2, further including a rear wall that extends upwardly providing depth to the pet bed and a front wall which is a lower height than the rear wall.
